(19) United States
(12) Patent Application Publication
(10) Pub. No.: US 2021/0024697 A1
(43) Pub. Date: Jan. 28, 2021

(54) Textile Care Product Having An Optionally Cross-Linked Copolymer And Method For Finishing Textiles

(71) Applicant: Henkel AG & Co. KGaA, Duesseldorf (DE)

(72) Inventors: Nadine Bluhm, Duesseldorf (DE); Peter Schmiedel, Duesseldorf (DE); Frank Janssen, Koeln (DE); Thomas Lohmeier, Rahden (DE); John Wong, CS Vaals (NL); Walter Richtering, Aachen (DE)

(21) Appl. No.: 17/069,667

(22) Filed: Oct. 13, 2020

Related U.S. Application Data
(63) Continuation of application No. PCT/EP2019/058130, filed on Apr. 1, 2019.

(30) Foreign Application Priority Data
Apr. 13, 2018 (DE) 102018003035.1

(51) Int. Cl. C08G 69/28; C08K 13/02; C11D 3/37; C11D 3/00; C11D 11/00

(52) U.S. Cl. CPC C08G 69/28; C08K 13/02; C08K 2003/387; C11D 3/0036; C11D 11/0017; C11D 3/3773

(57) ABSTRACT

The present invention relates to a textile care product containing a copolymer having N-isopropylacrylamide units, N-[3-(dimethylamino)propyl]methacrylamide units and optionally at least one cross-linking agent. The copolymer is used as a soil-release active ingredient, reduces or prevents re-soiling and improves the removal of soiling.

### FIELD OF THE INVENTION

The present invention relates to the use of a copolymer consisting of N-isopropylacrylamide units, N-[3-(dimethylamino)propyl]methacrylamide units and optionally at least one cross-linking agent, and to a textile care product which contains a copolymer of this kind, for reducing re-soiling of textiles or for improving the removal of soiling from textiles. In addition, the invention also relates to a method for finishing textiles using a soil-release protective layer and thus to a method by means of which re-soiling of textiles is reduced and/or the removability of soiling from textiles can be improved.

### BACKGROUND OF THE INVENTION

Daily use of textiles, for example textile clothing being worn, inevitably leads to the textiles getting stained. Many spots or stains, referred to collectively as “soiling” in the following, can be removed from the textiles, without leaving any residue, only with great difficulty or significant effort. This applies in particular to lipophilic products, such as lubricating oils, motor oils, greases, waxes and the like, but also, for example, to pigments. For reducing the staining of textiles, additives referred to as “soil-release” additives are proposed in the prior art, which additives are added to detergents and are absorbed by the surface of textiles during a washing process.

DE 101 525 308 A1 describes, for this purpose, the use of polymers consisting of polyisocyanates and polymeric polyols. DE 10 2007 013217 A1 also describes anionic soil-release polyesters consisting of terephthalic acid, sulfoisophthalic acid, (poly)alkylene glycol and a non-ionic end group.

However, the soil-release active ingredients known from the prior art either exhibit high selectivity for a specific form of soiling, i.e. only a certain type of dirt, for example only oil-based soiling, or only pigments or other more hydrophilic forms of soiling are removed, or only achieve their spectrum of effects on a particular type of fabric, for example only on fabrics based on polyamides or cotton.

Proceeding from this prior art, the object of the present invention is to provide the use of a copolymer consisting of N-isopropylacrylamide units, N-[3-(dimethylamino)propyl]methacrylamide units and optionally at least one cross-linking agent, and to provide a textile care product which prevents and/or reduces re-soiling of textiles or improves the removability of soiling from the textiles. Another object of the present invention is to provide a method for finishing textiles using a soil-release protective layer, by means of which method textiles are protected against re-soiling and/or soiling absorbed by the textile can be removed more easily.

### BRIEF SUMMARY OF THE INVENTION

It has surprisingly been found that this object is achieved by the use of a copolymer consisting of N-isopropylacrylamide units, N-[3-(dimethylamino)propyl]methacrylamide units and optionally at least one cross-linking agent (in short: NIPAM-co-DMAPMA). The N-isopropylacrylamide units and N-[3-(dimethylamino)propyl]methacrylamide units contained in the copolymer are represented by the following formulas:

### N-isopropylacrylamide (NIPAM):

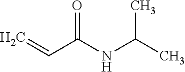

### N-[3-(dimethylamino)propyl]methacrylamide (DMAPMA):

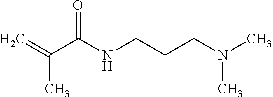

Without being bound by theory, it is assumed that, due to their chemical constitution, the N-isopropylacrylamide units contained in the copolymer are very effectively absorbed by different types of fabric, such as cellulose-based fabric (cotton), polyamide fabric, polyester fabric, blended fabric and the like, and form a kind of protective layer or protective film thereon that prevents unrestricted ingress of soiling on or in the fabric and therefore guards against soiling or re-soiling or effectively reduces or even prevents soiling or re-soiling. It is also assumed that the N-[3-(dimethylamino)propyl]methacrylamide units in the copolymer make it easier to remove the soiling from the fabric as a result of the high hydrophilic content produced by the methacrylamide units. The methacrylamide proportion in the N-[3-(dimethylamino)propyl]methacrylamide units also facilitates film formation on the fabric such that what is referred to as a soil-release protective layer can be formed uniformly on the surface of the fabric. A “protective covering” over a large area of the textile fabric is promoted by the sterically demanding chains of N-isopropylacrylamide units and N-[3-(dimethylamino)propyl]methacrylamide units, such that unrestricted ingress of soiling on or in the fabric is prevented or at least significantly reduced.

All in all, the copolymer used according to the invention is distinguished by a high hydrophilic content, but also a high lipophilic content, such that soiling of various types, i.e. lipophilic soiling such as greases, waxes or oils, and also hydrophilic soiling, such as pigments, dyes and the like, can additionally be reduced or even prevented or can be removed very easily.

The copolymer used according to the invention is preferably in the form of a hydrogel. Within the meaning of the invention, the term “hydrogel” is understood to mean a water-containing but water-insoluble copolymer of which the molecules are chemically linked, for example by covalent or ionic bonds, or physically linked, for example by loop formation in the polymer chains, so as to form a three-dimensional network. The hydrogel has the property of swelling in water, with a considerable increase in volume, while maintaining material coherency, as a result of the high hydrophilic content in the copolymer. In this way, separation and removal of soiling can be facilitated and thus improved.

Any agent that crosslinks the N-isopropylacrylamide units and/or N-[3-(dimethylamino)propyl]methacrylamide units can be used as the cross-linking agent. Cross-linking agents are preferably used which crosslink the acrylamide units or methacrylate units, such as in particular N,N′-methylenebisacrylamide (MBA), which is a symmetrical, non-conjugated bifunctional vinyl monomer.

In the copolymer used according to the invention, the molar ratio of units obtained from N-isopropylacrylamide to units obtained from the cross-linking agent is preferably in the range of from 1,000:1 to 10:1, in particular from 200:1 to 20:1 and particularly preferably from 50:1 to 25:1.

Furthermore, a textile care product which contains at least one copolymer consisting of N-isopropylacrylamide units, N-[3-(dimethylamino)propyl]methacrylamide units and optionally at least one cross-linking agent is also disclosed according to the invention. This includes the possibility of the textile care product according to the invention containing one or more copolymers consisting of N-isopropylacrylamide units, N-[3-(dimethylamino)propyl]methacrylamide units and optionally at least one cross-linking agent.

Within the meaning of the present invention, “textile care product” is understood to mean any washing, cleaning and care agent that is used for cleaning and caring for textiles, such as household and clothing textiles. These include in particular detergents, such as heavy-duty detergents, special detergents, such as mild detergents, wool detergents and the like, auxiliary detergents, laundry care agents, laundry sprays, ironing aids, laundry pretreatment agents and laundry aftertreatment agents.

To avoid redundancy, with regard to the definition of the copolymer consisting of N-isopropylacrylamide units, N-[3-(dimethylamino)propyl]methacrylamide units and optionally at least one cross-linking agent and the effects achieved according to the invention, reference is additionally made to the above explanations.

It has surprisingly been found that soiling or re-soiling of textiles of different types can be prevented or effectively reduced by the textile care product according to the invention, and it is also easier to remove soiling from the textiles. It is assumed that, in order to achieve these effects, the copolymer consisting of N-isopropylacrylamide units, N-[3-(dimethylamino)propyl]methacrylamide units and optionally at least one cross-linking agent is absorbed by the textile fabric and forms a kind of protective layer or protective film, prevents or at least reduces soiling and makes it easier to remove said soiling. The textiles treated with the textile care product according to the invention thus remain clean longer and can also be kept without any traces of previously existing soiling after several washes. It has been shown that the protective layer can be formed on different types of fabric, such as polyester-based fabric, cellulose-based fabric, polyamide-based fabric and any type of blended fabric. It has also been found that, by using the textile care product according to the invention, different types of soiling, i.e. both lipophilic soiling and hydrophilic soiling, can be reduced or even prevented or effectively removed.

### DETAILED DESCRIPTION OF THE INVENTION

An advantageous development of the textile care product according to the invention is distinguished in that the total mass of the copolymer consisting of N-isopropylacrylamide units, N-[3-(dimethylamino)propyl]methacrylamide units and optionally at least one cross-linking agent is from 0.001% by mass to 10% by mass, in particular from 0.01% by mass to 5% by mass, and more particularly 1% by mass, based on the total mass of the textile care product. If a plurality of copolymers consisting of N-isopropylacrylamide units, N-[3-(dimethylamino)propyl]methacrylamide units and optionally at least one cross-linking agent are used in combination, the total mass refers to the total mass of all copolymers consisting of N-isopropylacrylamide units, N-[3-(dimethylamino)propyl]methacrylamide units and optionally at least one cross-linking agent contained in the textile care product. In other words, this means that if, for example, two copolymers consisting of N-isopropylacrylamide units, N-[3-(dimethylamino)propyl]methacrylamide units and optionally at least one cross-linking agent are used in combination, their total mass is from 0.001% by mass to 10% by mass. If there is only one copolymer consisting of N-isopropylacrylamide units, N-[3-(dimethylamino)propyl]methacrylamide units and optionally at least one cross-linking agent in the textile care product according to the invention, its total mass is also preferably from 0.001% by mass to 10% by mass and in particular from 0.01% by mass to 5% by mass.

Even a low total mass of the copolymer used according to the invention of 0.001% by mass, and in particular of 0.01% by mass, brings about a significant reduction in soiling and an improvement in the removability of soiling absorbed by the textile fabric. It can therefore be assumed that a total mass of just 0.001% by mass of the copolymer to be used according to the invention leads to the formation of a soil-release protective layer which protects the fabric and is distinguished by a dirt-repellent effect. The higher the proportion of the copolymer consisting of N-isopropylacrylamide units, N-[3-(dimethylamino)propyl]methacrylamide units and optionally at least one cross-linking agent, the more extensive and homogeneous the protective layer formed on the fabric surface. Soiling can thus be reduced particularly effectively or even prevented if the total mass of this copolymer is from 0.01% by mass to 5% by mass. The spectrum of effects is particularly balanced in this range. Higher total masses of more than 5% by mass or even more than 10% by mass are disadvantageous with regard to the cost of the textile care product, and in particular from a total mass of more than 10% by mass of the copolymer no significant increase in the dirt-repellent effect and no further improvement in the removability of soiling can be observed. Rather, with such high proportions of the copolymer consisting of N-isopropylacrylamide units, N-[3-(dimethylamino)propyl]methacrylamide units and optionally at least one cross-linking agent, the haptic properties of the textile can be impaired.

According to an advantageous development, the textile care product contains at least one surfactant. The surfactant improves the removal of soiling. The addition of one or more surfactants is particularly advantageous if the textile care product is in the form of a detergent, such as a heavy-duty detergent, a mild detergent or a special detergent.

Within the meaning of the present invention, a surfactant is a surface-active substance which is able to remove dirt particles from the textile(s) during a washing process using the textile care product, due to micelles being formed. Suitable surfactants include cationic, anionic, non-ionic and amphoteric surfactants. Any mixtures of two or more surfactants can also be used, depending on the desired wash performance.

Suitable anionic surfactants include, but are not limited to, alkyl benzene sulfonates, olefin sulfonates, alkane sulfonates, fatty alcohol sulfates, fatty alcohol ether sulfates, or a mixture of two or more of these anionic surfactants. Of these anionic surfactants, alkylbenzene sulfonates, fatty alcohol ether sulfates and mixtures thereof are particularly preferred.

Surfactants of the sulfonate type that can be used are preferably alkylbenzene sulfonates, olefin sulfonates, i.e. mixtures of alkene and hydroxyalkane sulfonates, and disulfonates, as obtained, for example, from C₁₂₋₁₈ monoolefins having a terminal or internal double bond by way of sulfonation with gaseous sulfur trioxide and subsequent alkaline or acid hydrolysis of the sulfonation products. C₁₂₋₁₈ alkane sulfonates and the esters of α-sulfofatty acids (ester sulfonates) are also suitable, for example the α-sulfonated methyl esters of hydrogenated coconut, palm kernel or tallow fatty acids.

Alkylbenzene sulfonates are preferably selected from linear or branched mono- and dialkylbenzene sulfonates. The alkyl functional groups can contain individually or together 9 to 19, preferably 9 to 15, and in particular 9 to 13, C atoms. A very particularly preferred representative is sodium dodecylbenzene sulfonate.

The salts of the sulfuric acid half-esters of C₁₂-C₁₈ fatty alcohols, for example from coconut fatty alcohol, tallow fatty alcohol, lauryl, myristyl, cetyl or stearyl alcohol, or of C₁₀-C₂₀ oxo alcohols and the half-esters of secondary alcohols having these chain lengths are preferred as alk(en)yl sulfates. From a washing perspective, C₁₂-C₁₆ alkyl sulfates, C₁₂-C₁₅ alkyl sulfates and C₁₄-C₁₅ alkyl sulfates are preferred.

Alkyl ether sulfates of the formula

R¹—O-(AO)ₙ—SO₃⁻X⁺

are also suitable. In this formula, R¹ represents a linear or branched, substituted or unsubstituted alkyl functional group, preferably a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl and eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol, or from C₁₀-C₂₀ oxo alcohols.

AO represents an ethylene oxide (EO) group or propylene oxide (PO) group, preferably an ethylene oxide group. The index n represents an integer of from 1 to 50, preferably from 1 to 20, and in particular from 2 to 10. Very particularly preferably, n represents the numbers 2, 3, 4, 5, 6, 7 or 8. X represents a monovalent cation or the n-th part of an n-valent cation, the alkali metal ions, including Na⁺ or K⁺, being preferred in this case, with Na⁺ being most preferred. Further cations X⁺ can be selected from NH₄⁺, ½ ZN²⁺, ½ Mg²⁺, ½ Ca²⁺, ½ Mn²⁺, and mixtures thereof.

The anionic surfactants can be present in the form of the sodium, potassium, magnesium or ammonium salts thereof. The anionic surfactants are preferably present in the form of the sodium salts and/or ammonium salts thereof. Amines that can be used for neutralization are preferably choline, triethylamine, monoethanolamine, diethanolamine, triethanolamine, metyhlethylamine, or a mixture thereof, with monoethanolamine being preferred.

Suitable non-ionic surfactants include alkoxylated fatty alcohols, alkoxylated oxo alcohols, alkoxylated fatty acid alkyl esters, fatty acid amides, alkoxylated fatty acid amides, polyhydroxy fatty acid amides, alkylphenol polyglycol ethers, amine oxides, alkyl (poly)glucosides and mixtures thereof.

Preferred textile care products contain at least one fatty alcohol alkoxylate of the formula

R²—O-(AO)ₘ—H

in which
R² represents a linear or branched, substituted or unsubstituted alkyl functional group,
AO represents an ethylene oxide (EO) group or propylene oxide (PO) group,
m represents an integer from 1 to 50.

In the aforementioned formula, R² represents a linear or branched, substituted or unsubstituted alkyl functional group, preferably a linear, unsubstituted alkyl functional group, particularly preferably a fatty alcohol functional group. Preferred functional groups R² are selected from decyl, undecyl, dodecyl, tridecyl, tetradecyl, pentadecyl, hexadecyl, heptadecyl, octadecyl, nonadecyl and eicosyl functional groups and mixtures thereof, the representatives having an even number of C atoms being preferred. Particularly preferred functional groups R² are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

AO represents an ethylene oxide (EO) group or propylene oxide (PO) group, preferably an ethylene oxide group. The index m represents an integer from 1 to 50, preferably from 1 to 20, and in particular from 2 to 10. Very particularly preferably, m represents the numbers 2, 3, 4, 5, 6, 7 or 8.

According to a further advantageous development, in order to achieve particularly good wash performance involving a high dirt-removing power, the total mass of surfactant, i.e. the total mass of one or more surfactants, is from 1% by mass to 50% by mass, and in particular from 3% by mass to 20% by mass, based on the total mass of the textile care product. When using a combination of two or more surfactants, the total mass of surfactant refers to the total mass of all surfactants used.

More preferably, the textile care product is present as a powder, liquid or gel, or in the form of tablets or capsules. The liquid form is particularly preferable, since, in liquid textile care products, the copolymer consisting of N-isopropylacrylamide units, N-[3-(dimethylamino)propyl]methacrylamide units and optionally at least one cross-linking agent is hydrated and is therefore present in particular in the form of a hydrogel which is particularly easily absorbable by textiles and can form a dirt-repellent protective layer.

The textile care product can contain other conventional ingredients. Unless otherwise indicated, all amounts indicated in connection with the ingredients of the textile care product described herein refer to % by mass, in each case based on the total mass of the textile care product.

Moreover, amounts that relate to at least one ingredient always relate to the total amount of this type of ingredient contained in the textile care product, unless explicitly indicated otherwise. This means that specified amounts of this type, for example in connection with “at least one surface-active substance,” refer to the total amount of surface-active substances contained in the textile care product.

“At least one,” as used herein, refers to one or more, for example 1, 2, 3, 4, 5, 6, 7, 8, 9 or more. In connection with ingredients of the textile care product described herein, this number does not refer to the absolute amount of molecules, but to the type of constituent. “At least one enzyme” or “at least one surface-active substance” therefore means, for example, one or more different enzymes or surface-active substances, i.e. one or more different types of enzymes or surface-active substances. Together with stated amounts, the stated amounts refer to the total amount of the correspondingly designated type of constituent, as defined above.

In addition, the textile care product according to the invention can also contain other ingredients which further improve the practical and/or aesthetic properties of the textile care product. In the context of the present invention, the textile care product preferably additionally contains one or more substances from the group of bleaching agents, enzymes, complexing agents, builders, electrolytes, non-aqueous solvents, pH adjusters, perfumes, perfume carriers, fluorescing agents, dyes, hydrotropes, suds suppressors, silicone oils, anti-redeposition agents, graying inhibitors, anti-shrink agents, anti-crease agents, dye transfer inhibitors, antimicrobial active ingredients, germicides, fungicides, antioxidants, preservatives, corrosion inhibitors, antistatic agents, bittering agents, ironing aids, repellents and impregnating agents, swelling and anti-slip agents, softening components and UV absorbers.

All substances which destroy or absorb dyes by means of oxidation, reduction or adsorption, and thus decolorize materials, can be used as bleaching agents. These include, inter alia, hypohalite-containing bleaching agents, hydrogen peroxide, perborate, percarbonate, peracetic acid, diperoxyazelaic acid, diperoxy dodecanedioic acid and oxidative enzyme systems.

Suitable builders that can be contained in the textile care product are in particular silicates, aluminum silicates (in particular zeolites), carbonates, salts of organic di- and polycarboxylic acids, and mixtures of these substances.

Organic builders which may be present in the textile care product are, for example, the polycarboxylic acids that can be used in the form of the sodium salts thereof, polycarboxylic acids being understood to mean those carboxylic acids that carry more than one acid function. These include, for example, citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acids, citric acid, adipic acid, succinic acid, glutaric acid, tartaric acid, saccharic acids, and mixtures thereof.

Polymeric polycarboxylates are also suitable as builders. These are, for example, the alkali metal salts of polyacrylic acid or of polymethacrylic acid, for example those having a relative molecular mass of from 600 to 750,000 g/mol.

Suitable polymers are in particular polyacrylates which preferably have a molecular mass of from 1,000 to 15,000 g/mol. Due to their superior solubility, the short-chain polyacrylates, which have molar masses of from 1,000 to 10,000 g/mol, and particularly preferably from 1,000 to 5,000 g/mol, can in turn be preferred from this group.

In addition, copolymeric polycarboxylates are suitable, in particular those of acrylic acid with methacrylic acid and of acrylic acid or methacrylic acid with maleic acid. To improve water solubility, the polymers can also contain allyl sulfonic acids, such as allyloxybenzene sulfonic acid and methallyl sulfonic acid, as monomers.

Soluble builders, such as citric acid, or acrylic polymers having a molar mass of from 1,000 to 5,000 g/mol are preferably used in liquid textile care products.

Liquid textile care products also preferably contain water as the main solvent. It is preferable for the textile care product to contain more than 5% by mass, preferably more than 15% by mass and particularly preferably more than 25% by mass, of water, in each case based on the total mass of the textile care product. Particularly preferred liquid textile care products contain from 5% by mass to 90% by mass, preferably from 10% by mass to 85% by mass, particularly preferably from 25% by mass to 75% by mass, and more particularly preferably from 35% by mass to 65% by mass, of water.

Alternatively, the textile care product according to the invention can be a low-water to water-free textile care product, the total mass of water in a preferred embodiment being less than 10% by mass and more preferably less than 8% by mass, in each case based on the total mass of the textile care product.

In addition, non-aqueous solvents can be added to the textile care product. Suitable non-aqueous solvents include monovalent or polyvalent alcohols, alkanol amines or glycol ethers, if they can be mixed with water in the stated concentration range. The solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butylether, di-n-octylether and mixtures of these solvents. It is however preferable for the textile care product to contain an alcohol, in particular ethanol and/or glycerol, in an amount of between 0.5 and 5% by mass, based on the total mass of the textile care product.

The conventional enzyme stabilizers, which may optionally be present, in particular in liquid textile care products, include amino alcohols, for example mono-, di-, triethanol- and propanolamine and mixtures thereof, lower carboxylic acids, boric acid, alkali borates, boric acid-carboxylic acid combinations, boric acid esters, boric acid derivatives, calcium salts, for example a Ca-formic acid combination, magnesium salts, and/or sulfur-containing reducing agents.

Soaps can be used as further surface-active ingredients, soaps of C₁₂-C₁₈ fatty acids being preferred. They can also be present in the form of the sodium, potassium, magnesium or ammonium salts thereof.

The textile care product according to the invention can contain one or more enzymes. In principle, all the enzymes found in the prior art for this purpose can be used in this regard. This at least one enzyme is preferably one or more enzymes which can develop catalytic activity in a textile care product, in particular a protease, cellulase, amylase, lipase, mannanase, pectin-cleaving enzyme, tannase, xylanase, xanthanase, β-glucosidase, carrageenanase, perhydrolase, oxidase, oxidoreductase, and mixtures thereof. Preferred hydrolytic enzymes include in particular proteases, amylases, in particular α-amylases, lipases, in particular pectinases, mannanases, β-glucanases, and mixtures thereof. In principle, these enzymes are of natural origin. Proceeding from the natural molecules, improved derivatives for use in textile care products are available which are preferably used accordingly.

Furthermore, a method for finishing textiles using a soil-release protective layer is also described according to the invention, which method comprises the following method steps:

a. providing a textile care product as defined above, and
b. bringing a textile into contact with the textile care product.

For this purpose, the textile care product can be prepared in the form of a solution (wash liquor) to facilitate contact with the textile. By using or carrying out the method according to the invention, the textiles treated according to the invention are provided with a kind of dirt-repellent protective layer, which effectively reduces or even prevents soiling and facilitates and thus improves the removal of soiling or re-soiling absorbed by the textile.

It is assumed that, using the method, soiling is prevented from penetrating the textiles and at most remains on the surface thereof, and in particular on the protective layer or the protective film thereon. The soiling can be removed very easily from said surface, for example by being separated with part of the protective layer or also with the entire protective layer, and in particular by being washed out. Washing out is promoted in particular by the hydrophilic content of the copolymer, i.e. in particular the N-[3-(dimethylamino)propyl]methacrylamide units. The method is simple, can be implemented without great technical effort, and protects the treated textiles from staining. The advantageous effects are achieved for different types of textiles (for example cotton-based textiles, polyamide-based textiles, polyester-based textiles and any type of blended fabric) as well as for different forms of soiling (hydrophilic and hydrophobic soiling).

A further aspect of the present invention also describes the use of a textile care product as disclosed above for reducing re-soiling of textiles and improving the removal of soiling from textiles. These effects are achieved for different types of textiles (for example cotton-based textiles, polyamide-based textiles, polyester-based textiles and blended fabrics) and different forms of soiling as a result of the copolymer consisting of N-isopropylacrylamide units, N-[3-(dimethylamino)propyl]methacrylamide units and optionally at least one cross-linking agent that is present in the textile care product according to the invention.

### Example

### Example 1: Preparation of NIPAM-co-DMAPMA

A copolymer consisting of N-isopropylacrylamide units, N-[3-(dimethylamino)propyl]methacrylamide units and cross-linking agents (in short: NIPAM-co-DMAPMA polymer) was prepared following the below preparation instructions:

A solution of 2.80 g of N-[3-(dimethylamino)propyl]methacrylamide (DMAPMA) in 140 ml of degassed water was added, with constant stirring, to a solution of 17.09 g of N-isopropylacrylamide (NIPAM) and 0.79 g of N,N′-methylenebis(acrylamide) (BIS) in 940 ml of degassed water, which solution had been heated to 90° C. under a nitrogen atmosphere, and the pH of the mixture was adjusted to 10 using 0.1 M NaOH. A solution of 0.36 g of cetyltrimethylammonium chloride (CTAB) in 100 ml of degassed water was then added. A solution of 0.14 g of 2,2′-azobis(2-methylpropionamidine)-dihydrochloride (AAPH) in 20 ml of degassed water was also added so as to start the polymerization reaction. The reaction mixture obtained was constantly stirred (300 rpm) for 4 h at 85° C. under a nitrogen atmosphere and then cooled, with constant stirring (300 rpm), to room temperature.

The NIPAM-co-DMAPMA was obtained with a 74% yield and had a hydrodynamic radius (Rh) of 146 nm in water at 20° C. The zeta potential was 16 mV in water at 20° C.

### Example 2: Liquid Textile Care Product

The following textile care products were prepared by mixing the constituents shown in Table 1. Textile care products V1 and V2 are not formulations according to the invention and are used as reference, whereas textile care product E1 represents an embodiment according to the invention which contains a copolymer consisting of N-isopropylacrylamide units, N-[3-(dimethylamino)propyl]methacrylamide units and a cross-linking agent. The copolymer from Example 1 was used as the copolymer.

TABLE 1
Composition of textile care products [% by mass]

| | V1 | V2 | E1 |
|---|---|---|---|
| Boric acid | 1 | 1 | 1 |
| Citric acid | 2.2 | 2.2 | 2.2 |
| Anti-foaming agents | 0.03 | 0.03 | 0.03 |
| Surfactants | 18 | 18 | 18 |
| Fatty acid from palm kernel oil | 2.25 | 2.25 | 2.25 |
| NaOH | 2.334 | 2.334 | 2.334 |
| Glycerol | 2.5 | 2.5 | 2.5 |
| Preservatives | 0.0 | 0.05 | 0.05 |
| Ethanol | 1.25 | 1.25 | 1.25 |
| Phosphonate DTPMP | 0.5 | 0.5 | 0.5 |
| Optical brightener | 0.035 | 0.035 | 0.035 |
| Enzyme mix | 0.836 | 0.836 | 0.836 |
| Perfume | 0.741 | 0.741 | 0.741 |
| Dye | 0.006 | 0.006 | 0.006 |
| Poly-NIPAM | — | 1 | — |
| NIPAM-co-DMAPMA | — | — | 1 |

| | |
|---|---|
| Water | to make up to 100 |

The pH of the textile care products was between 8.2 and 8.6. The density of the textile care products was between 1.044 and 1.054 g/cm³ at 20° C.

### Example 3: Soil-Release Effect

3.5 kg of clean ballast laundry (including the following test textiles: pillow, jersey, kitchen towel) was washed three times with 66 ml of one of the textile care products (V1, V2, E1) from Example 2 in a Miele W 918 Novotronic® with a washing volume of 17 L and a water hardness of 16° dH at 40° C. After the washing process, the laundry was air-dried.

The test textiles were then soiled with standardized soiling and stored at room temperature for 7 days. The test textiles were then washed again under the conditions described above together with the remaining ballast laundry in a wash liquor which contained 66 ml of the same textile care product from Example 2 as previously used. The remaining stain intensity was determined using a DATA COLOR Spectra Flash SF500 remission spectrometer.

Table 3 shows the obtained test results with regard to stain intensity

TABLE 3
Results with regard to stain intensity

| Soiling | Textile | V2 | E1 |
|---|---|---|---|
| Palm fat | Cotton | 3.6 | 4.2 |
| Lard | Polyester | 1.6 | 3.7 |
| Black shoe polish | Polyester | 12.1 | 14.4 |
| Make up | Cotton | 12.0 | 13.6 |

Delta-delta-Y values are given by comparison with the use of detergent V1. For the forms of soiling used, the textile care product E1, which contained a copolymer which consisted of N-isopropylacrylamide units, N-[3-(dimethylamino)propyl]methacrylamide units and a cross-linking agent, gave the best test results.

What is claimed is:

1. A textile care product comprising at least one copolymer consisting of N-isopropylacrylamide units, N-[3-(dimethylamino)propyl]methacrylamide units and optionally at least one cross-linking agent.

2. The textile care product according to claim 1, wherein the total mass of the copolymer comprising N-isopropylacrylamide units, N-[3-(dimethylamino)propyl]methacrylamide units and optionally at least one cross-linking agent is from 0.001% by mass to 10% by mass, based on the total mass of the textile care product.

3. The textile care product according to claim 2, wherein the total mass of the copolymer consisting of N-isopropylacrylamide units, N-[3-(dimethylamino)propyl]methacrylamide units and optionally at least one cross-linking agent is from 0.01% by mass to 5% by mass based on the total mass of the textile care product.

4. The textile care product according to claim 1, wherein the textile care product further comprises at least one surfactant, wherein the total mass of surfactant is from 1% by mass to 50% by mass based on the total mass of the textile care product.

5. The textile care product according to claim 1, wherein the textile care product is present as a powder, liquid or gel, or in the form of tablets or capsules.

6. The textile care product according to claim 1, wherein the textile care product is in the form of an auxiliary detergent, a laundry care agent, or a laundry aftertreatment agent.

7. A method for finishing textiles using a soil-release protective layer, comprising the method steps of:
a) providing a textile care product according to claim 1, and
b) bringing a textile into contact with the textile care product.
